(19) United States
(12) Patent Application Publication
(10) Pub. No.: US 2018/0281670 A1
(43) Pub. Date: Oct. 4, 2018

(54) ALARM DEVICE

(71) Applicant: HON HAI PRECISION INDUSTRY CO., LTD., New Taipei (TW)

(72) Inventors: PO-CHENG CHEN, New Taipei (TW); YA-KUAN CHUANG, New Taipei (TW); YU-WEN CHEN, New Taipei (TW); WEI-CHUN CHEN, New Taipei (TW)

(21) Appl. No.: 15/481,481

(22) Filed: Apr. 7, 2017

(30) Foreign Application Priority Data
Mar. 29, 2017 (CN) 201710197258.9

(51) Int. Cl. B60Q 1/46; B60Q 1/52

(52) U.S. Cl. CPC B60Q 1/46; B60Q 1/52

(57) ABSTRACT

A traffic warning device removably mounted to a vehicle and coupled to a main controller. The main controller includes an alarm unit to output warning. A driving unit in the device receives a driving signal from the main controller and moves accordingly. A power supply unit supplies power to the alarm unit and the driving unit.

### FIELD

The subject matter herein generally relates to alarm devices.

### BACKGROUND

In recent years, the frequency of traffic accidents has been increasing, especially in vehicle rear-end accidents.

A main controller can remotely control an alarm device to move so as to give warning, but the required power consumption will be much larger than merely flashing diode lights on a tripod. Thus, there is room for improvements in the art.

### BRIEF DESCRIPTION OF THE DRAWINGS

Implementations of the present technology will now be described, by way of example only, with reference to the attached figures.

FIG. 1 is a block diagram of an exemplary embodiment of an alarm device with a main controller.

FIG. 2 is a schematic diagram of the alarm device of FIG. 1.

FIG. 3 is a block diagram of a power supply unit of the alarm device of FIG. 1.

FIG. 4 is a block diagram of an interface module of the alarm device of FIG. 3.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the exemplary embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected.

The term “comprising” means “including, but not necessarily limited to”; it specifically indicates open-ended inclusion or membership in a so-described combination, group, series, and the like.

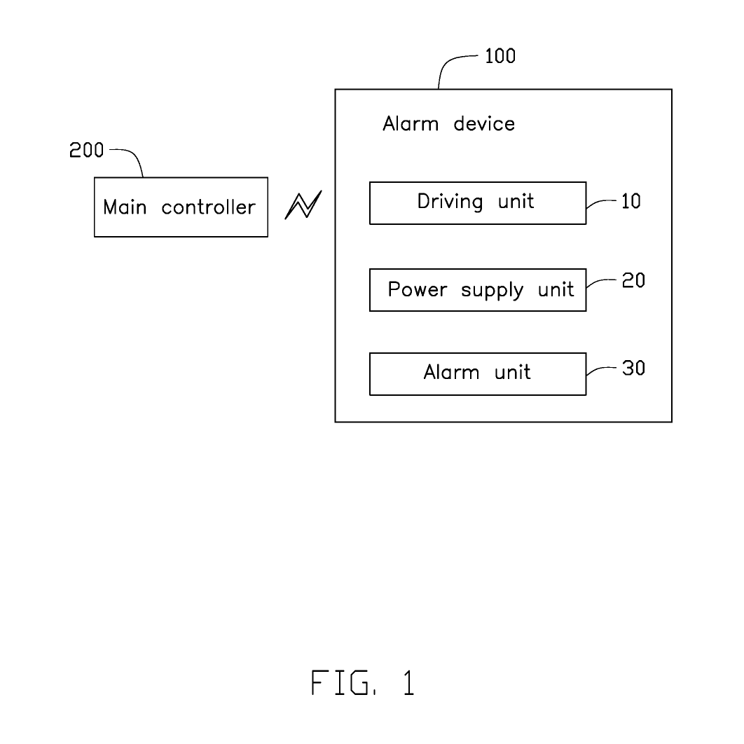

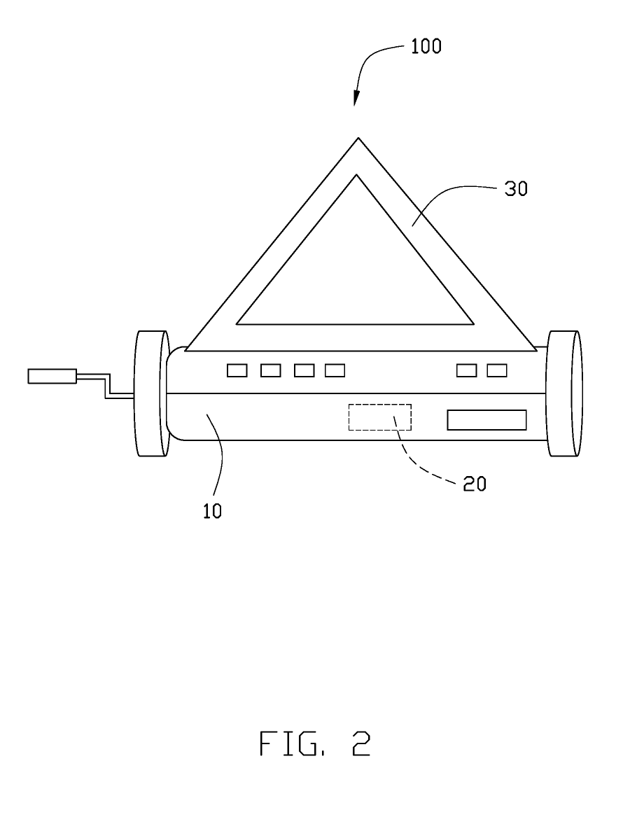

FIG. 1 and FIG. 2 illustrate an alarm device 100 in an exemplary embodiment. The alarm device 100 is removably mounted to a vehicle and configured to give warning for a traffic accident.

The alarm device 100 comprises a driving unit 10, a power supply unit 20, and an alarm unit 30

In at least one embodiment, the alarm device 100 is wirelessly coupled to a main controller 200.

The main controller 200 is configured to send a driving signal to the driving unit 10.

The driving unit 10 is configured to receive the driving signal and drive the alarm device 100 to move according to the driving signal.

In at least one embodiment, the alarm device 100 is a warning triangle, and the main controller 200 is a mobile phone.

The alarm unit 30 is configured to output an alarm signal to provide warning about an existing traffic-related obstacle.

In at least one exemplary embodiment, the alarm signal is a flashing light.

The power supply unit 20 is configured to supply power to the driving unit 10 and the alarm unit 30.

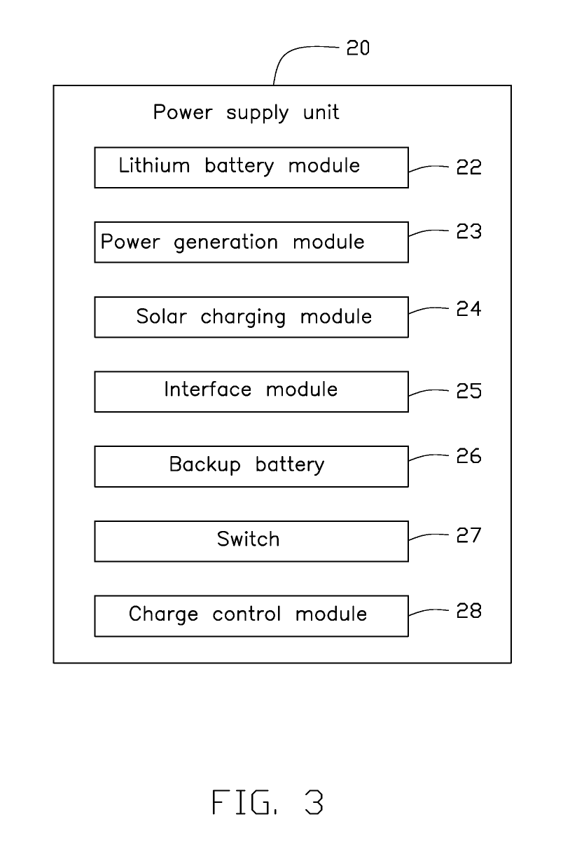

FIG. 3 illustrates that the power supply unit 20 comprises a lithium battery module 22, a power generation module 23, a solar charging module 24, an interface module 25, a backup battery 26, and a switch 27.

The lithium battery module 22 is configured to supply power to the driving unit 10 and the alarm unit 30.

The power generation module 23 is configured to generate power and store the generated electric energy to the lithium battery module 22.

In at least one exemplary embodiment, the power generation module 23 is a hand-cranked generator.

The solar charging module 24 is configured to convert solar energy into electrical energy and store the electric energy to the lithium battery module 22.

In at least one embodiment, the solar charging module 24 collects solar energy by means of a solar energy collecting plate (not shown in figures), which can be magnetically attached on the rear of the car to collect solar energy.

The interface module 25 is configured to receive different types of voltages and transmit the received different types of voltage to charge the lithium battery module 22.

In addition, the interface module 25 is also configured to transmit the electrical energy that is stored in the lithium battery module 22 at different types of voltage to charge an external electronic device, such as a mobile phone.

When the switch 27 is switched on, the alarm device 100 is activated.

When the power of the lithium battery module 22 is completely exhausted, the backup battery 26 will supply power to the alarm unit 30, so that it is still possible for the alarm unit 30 to function in the case of lithium battery module 22 are without electrical power.

The power supply unit 20 further comprises a charge control module 28, and the charge control module 28 is configured to control the lithium battery module 22 to receive a single power supply for charging.

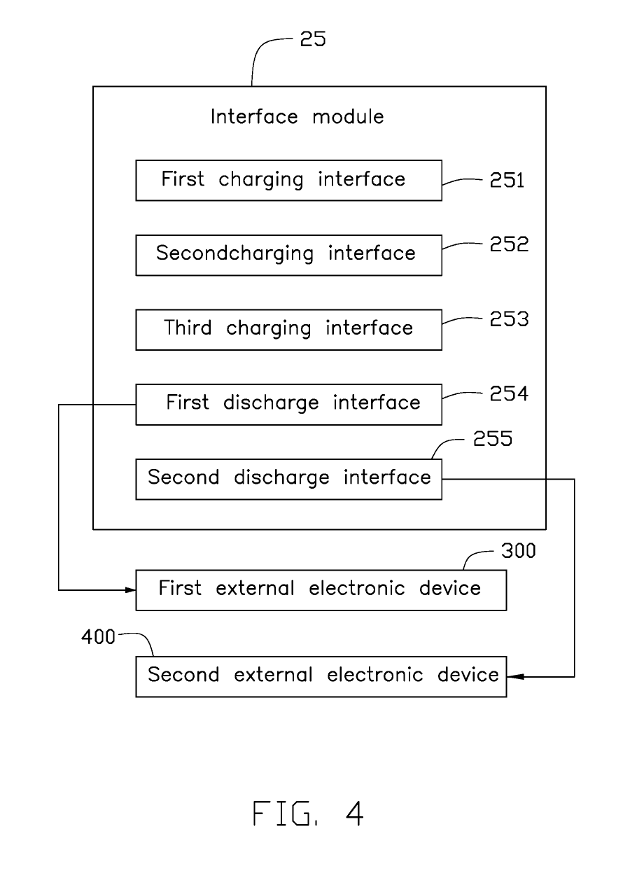

FIG. 4 illustrates that the interface module 25 comprises a first charging interface 251, a second charging interface 252, a third charging interface 253, a first discharge interface 254, and a second discharge interface 255.

The first charging interface 251, the second charging interface 252, and the third charging interface 253 are three different types of charging interfaces to connect different types of charging interfaces of an external power source. The charging interfaces may be a universal serial bus (USB) interface, a power adapter interface, and an alternating current (AC) charging plug, in order to charge the lithium battery module 22.

The first discharge interface 254 is configured to output a first voltage to charge a first external electronic device 300.

The second discharge interface 255 is configured to output a second voltage to charge a second external electronic device 400.

In at least one exemplary embodiment, the first voltage is a 5V direct current (DC) voltage.

In at least one exemplary embodiment, the second voltage is a 12V direct current voltage.

When a traffic accident occurs, the driver presses the switch 27 and places the alarm device 100 on the road surface. At this time, the power supply unit 20 supplies power to the alarm unit 30 and the driving unit 10, and the alarm unit 30 outputs at least one alarm signal to warn other drivers.

Thus, the alarm device 100 can be automatically moved by the main controller 200 to a safe distance to warn other drivers when a road obstacle is present.

When the power in the lithium battery module 22 is completely exhausted, the backup battery 26 can still continue to supply power to the alarm unit 30.

The exemplary embodiments shown and described above are only examples. Many details are often found in the art such as the other features of alarm device. Therefore, many such details are neither shown nor described.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

1. An alarm device providing warning for a traffic accident, and coupled to a main controller, comprising:
an alarm unit outputting an alarm signal to provide warning of the traffic accident;
a driving unit receiving a driving signal from the main controller, and driving the alarm device to move; and
a power supply unit supplying power to the alarm unit and the driving unit
wherein the power supply unit comprises a lithium battery module, the lithium battery module supplies power to the driving unit and the alarm unit and
wherein the power supply unit further comprises a solar charging module, the solar charging module converts solar energy into electrical energy and stores the electric energy to the lithium battery module.

2. The alarm device of claim 1, wherein the alarm signal is a flashing light.

3. (canceled)

4. The alarm device of claim 1, wherein the power supply unit further comprises a power generation module, the power generation generates electrical energy and stores the electric energy to the lithium battery module.

5. The alarm device of claim 1, wherein the power generation module is a hand-cranked generator.

6. (canceled)

7. The alarm device of claim 1, wherein the power supply unit further comprises a backup battery, when power of the lithium battery module is completely exhausted, the backup battery supplies power to the alarm unit.

8. The alarm device of claim 1, wherein the power supply unit further comprises an interface module, the interface module receives different types of voltages and transmits the received different types of voltages to charge the lithium battery module.

9. The alarm device of claim 8, wherein the interface module transmits the electrical energy of the lithium battery module at different types of voltages to charge an external electronic device.

10. The alarm device of claim 9, wherein the interface module comprises a first discharge interface, the first discharge interface outputs a first voltage to charge a first external electronic device.

11. The alarm device of claim 10, wherein the interface module comprises a second discharge interface, the second discharge interface outputs a second voltage to charge a second external electronic device.

12. The alarm device of claim 11, wherein the first voltage is a 5V direct current (DC) voltage, and the second voltage is a 12V DC voltage.

13. An alarm device providing warning for a traffic accident, and coupled to a main controller, comprising:
an alarm unit outputting an alarm signal to provide warning of the traffic accident;
a driving unit receiving a driving signal from the main controller, and driving the alarm device to move; and
a power supply unit comprising:
a lithium battery module supplying power to the driving unit and the alarm unit; and
a power generation module generating electrical energy and storing the electric energy to the lithium battery module;
wherein the power supply unit further comprises a solar charging module, the solar charging module converts solar energy into electrical energy and stores the electric energy to the lithium battery module.

14. The alarm device of claim 13, wherein the alarm signal is a flashing light.

15. The alarm device of claim 13, wherein the power generation module is a hand-cranked generator.

16. (canceled)

17. The alarm device of claim 13, wherein the power supply unit further comprises a backup battery, when power of the lithium battery module is completely exhausted, the backup battery supplies power to the alarm unit.

18. The alarm device of claim 13, wherein the power supply unit further comprises an interface module, the interface module receives different types of voltages and transmits the received different types of voltages to charge the lithium battery module.

19. The alarm device of claim 18, wherein the interface module transmits the electrical energy of the lithium battery module at different types of voltages to charge an external electronic device.

20. The alarm device of claim 19, wherein the interface module comprises a first discharge interface and a second discharge interface, the first discharge interface outputs a first voltage to charge a first external electronic device, and the second discharge interface outputs a second voltage to charge a second external electronic device.
